(19) United States
(12) Patent Application Publication
(10) Pub. No.: US 2022/0006124 A1
(43) Pub. Date: Jan. 6, 2022

(54) METHODS OF IMPROVING PERFORMANCE OF IONIC LIQUID ELECTROLYTES IN LITHIUM-ION BATTERIES

(71) Applicant: The Regents of the Universityof Colorado, a body corporate, Denver, CO (US)

(72) Inventors: Se-Hee Lee, Denver, CO (US); Ashley Heist, Denver, CO (US)

(21) Appl. No.: 17/284,402

(22) PCT Filed: Oct. 9, 2019
(86) PCT No.: PCT/US2019/055457

§ 371 Date: Apr. 9, 2021

Related U.S. Application Data
(60) Provisional application No. 62/743,426, filed on Oct. 9, 2018.

(51) Int. Cl. H01M 10/0568; H01M 10/0525; H01M 10/44

(52) U.S. Cl. CPC H01M 10/0568; H01M 10/0525; H01M 2004/028; H01M 2300/0045; H01M 10/44

(57) ABSTRACT

Methods of improving the performance of an energy storage device are described. The method can include providing an energy storage device, which may be a lithium ion battery. The provided energy storage device may include an electrode and a room temperature ionic liquid electrolyte. The room temperature ionic liquid electrolyte may include a lithium salt, wherein the concentration of the lithium salt in the room temperature ionic liquid is greater than 1.2M, such as from 2.4M to 3.0M. The method may further include charging and discharging the provided energy storage device. Other methods described include providing an energy storage device comprising an electrode and a room temperature ionic liquid electrolyte, heating the energy storage device to a temperature above ambient temperature (e.g., 45° C.) and charging and discharging the energy storage device. Still other methods include both the use of the high lithium salt concentration room temperature ionic liquid electrolyte and heating the energy storage device.

### CROSS-REFERENCE TO RELATED APPLICATION(S)

This application is a National Stage Application of PCT/US2019/055457 filed on Oct. 9, 2019, which claims the benefit of and priority to U.S. Provisional Patent Application No. 62/743,426, filed Oct. 9, 2018 and entitled “METHODS TO IMPROVE PERFORMANCE OF IONIC LIQUID ELECTROLYTES IN LITHIUM-ION BATTERIES”, the entirety of which is herein incorporated by reference. U.S. Patent Application Publication No. 2018/0006294, entitled “Ionic Liquid-Enabled High-Energy Li-Ion Batteries” and U.S. Patent Application Publication No. 2017/0338474, entitled “Stable Silicon-Ionic Liquid Interface Lithium-Ion Batteries” are also herein incorporated by reference in their entirety.

### TECHNICAL FIELD

The present application relates to methods of improving the performance of ionic liquid electrolytes in lithium-ion batteries, and more specifically to improving at least the performance at high cycling (charge/discharge) rate, the long term (overall) cycling performance, or both of lithium-ion batteries.

### BACKGROUND

While conventional organic electrolyte solutions are susceptible to spontaneous combustion caused by thermal runaway, room temperature ionic liquids (also referred to herein simply as ionic liquids) have proven to be a far safer and electrochemically superior electrolyte alternative. In addition to being non-flammable and non-volatile, ionic liquid electrolytes form favorable passivation layers on many high-energy electrode materials, effectively protecting those materials from cycling-induced degradation and enabling more complete utilization of the active material. However, due to their higher viscosity and lower ionic conductivity compared to organic electrolytes, most ionic liquid electrolytes suffer from poor performance at high charge and discharge rates. As a result, poor rate capability is commonly recognized as one of the primary disadvantages of ionic liquid electrolytes.

Accordingly, a need exists for methods of improving the performance of ionic liquid electrolytes in lithium-ion batteries.

### BRIEF DESCRIPTION OF THE DRAWINGS

FIG. 1 is a flow chart illustrating a method of improving energy storage device performance according to various embodiments described herein.

FIGS. 2A and 2B are graphs illustrating cycling performance of previously known energy storage devices.

FIGS. 3A and 3B are graphs illustrating cycling performance of energy storage devices according to various embodiments described herein.

FIG. 4 is a graph illustrating ionic conductivity and lithium ion transference number measurements of energy storage devices according to various embodiments described herein.

FIG. 5 is a flow chart illustrating a method of improving energy storage device performance according to various embodiments described herein.

FIGS. 6A and 6B are graphs illustrating cycling performance of energy storage devices according to various embodiments described herein.

FIG. 7 is a flow chart illustrating a method of improving energy storage device performance according to various embodiments described herein.

### DETAILED DESCRIPTION

Described herein are various embodiments of methods for improving the performance of ionic liquid electrolytes in lithium-ion batteries. In some embodiments, the method includes the use of high concentrations of a lithium salt in the ionic liquid electrolyte to significantly increases the kinetic capabilities of the ionic liquid electrolytes at high charge/discharge rates. In some embodiments, the method includes the use of ambient heating during cycling to improve the overall cycling performance of ionic liquid electrolytes. In some embodiments, both high lithium salt concentrations and ambient heating are used to improve ionic liquid electrolyte performance.

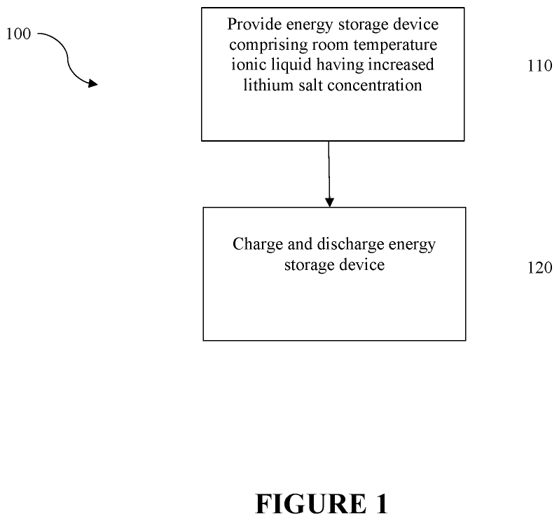

With reference to FIG. 1, a method 100 for improving the performance of ionic liquid electrolytes in lithium-ion batteries according to various embodiments described herein generally includes a step 110 of providing an energy storage device comprising a room temperature ionic liquid electrolyte having an increased lithium salt concentration, and a step 120 charging and discharging energy storage device.

With respect to step 110, the energy storage device generally includes an anode, a cathode, and an ionic liquid electrolyte. In the case where the energy storage device is a lithium ion battery, the energy storage device will include cathodes and anodes suitable for use in lithium ion batteries and a lithium salt-based ionic liquid electrolyte.

With respect to the cathode material, an exemplary, non-limiting, cathode material type suitable for use in the energy storage device includes intercalation type cathode material. Intercalation-type cathodes may include layered lithium metal oxide, olivine-type cathode material and spinel-type cathode material. In some embodiments, layered lithium metal oxide materials are specifically used. Exemplary layered lithium metal oxide materials include, but are not limited to Nickel/Manganese/Cobalt (NMC) or Nickel/Cobalt/Manganese (NCM) materials. The ratio of the components of NMC or NCM materials are generally not limited, and may include, for example, NMC-111 (equal proportions of each), NMC-811 (Nickel-rich) and other ratios where Nickel is the predominant component to provide higher energy density. In some embodiments, Nickel-rich compositions are preferred since the ionic liquid electrolyte can stabilize the highly-reactive Nickel-rich material without need for surface coatings on the cathode (as discussed in greater detail below). Other suitable layered lithium metal oxide materials include Nickel/Cobalt/Aluminum (NCA) or Nickel/Manganese/Cobalt/Aluminum (NMCA) materials. As with NMC and NCM materials, the NCA and NMCA materials can include any proportions of the components, though in some embodiments, there is a preference for Nickel-rich NCA or NMCA. Still other suitable layered lithium metal oxide materials include Lithium/Cobalt/Oxide (LCO). Exemplary olivine-type cathode material includes, LiFePO₄, and exemplary spinel-type cathode material includes LiMn₂O₄. It is also possible that the energy storage device may be able to use conversion-type cathodes.

With respect to the anode material, an exemplary, non-limiting, anode material suitable for use in the energy storage device includes intercalation-type anode material. Intercalation-type anodes may include graphite-based anodes. Graphite has a layered structure similar to the layered lithium metal oxide materials discussed above with respect to exemplary cathode materials. Other suitable anode materials include alloying-type anode materials. Alloying-type anode materials can include silicon and silicon oxide, tin and tin oxide, and germanium and germanium oxide. Lithium-metal anode material can also be used, though the use of such material technically makes the energy storage device a lithium-metal battery rather than a lithium ion battery. The technology described herein, and specifically the use of higher concentrations of lithium salts in the electrolyte, has been shown to mitigate dendrite growth when lithium-metal anodes are used, thereby reducing some of the concerns that exist with respect to the use of lithium metal anodes, such as short-circuiting.

In some embodiments, the electrodes (cathodes and/or anodes) of the energy storage device provided in step 110 are uncoated electrodes (i.e., free of protective coatings). In many previously known energy storage devices, protective layers are added to the electrodes in order to impeded electrode degradation. In the embodiments described herein, such protective layers (e.g., aluminum oxide layers, metal oxide layers, etc.) may be eliminated, as the electrolyte with increased lithium salt concentration can help to mitigate electrode degradation to the point of rendering a protective layer unnecessary.

With respect to the ionic liquid electrolyte component of the energy storage device, the ionic liquid electrolyte will generally include an ionic liquid solvent and a lithium salt. The ionic liquid solvent comprises a cation/anion pairing such that the resulting material presents as a liquid at or near room temperature. Exemplary, though non-limiting, cation types suitable for use in the solvent component of the ionic liquid electrolyte include pyrrolidinium (e.g., N-methyl-N-propylpyrrolidinium, 1-butyl-1-methylpyrrolidinium), piperidinium (e.g., N-methyl-N-propylpiperidinium, 1-hexyl-1-methyl piperidinium), imidazolium (e.g., 1-ethyl-3-methylimidazolium, 1-butyl-3-methylimidazolium), pyridinium (e.g., 1-butyl-4-methylpyridinium, 1-ethylpyridinium), ammonium (e.g., tetrabutylammonium, butyltrimethylammonium), and phosphonium (e.g., tributyl(hexyl)phosphonium, tributyl((2-methoxyethoxy)methyl)phosphonium). Exemplary, though non-limiting, anion types suitable for use in the solvent component of the ionic liquid electrolyte include halides (e.g., chloride, bromide, iodide), inorganic anions (e.g., hexafluorophosphate, tetrafluoroborate, tetra chloroaluminate), organic anions (e.g., bis(fluorosulfonyl)imide, bis(trifluoromethanesulfonly)imide), and cyanic anions (e.g., dicyanamide, thiocyanate)

For the lithium salt component of the ionic liquid electrolyte, exemplary, though non-limiting, salts include LiPF₆, LiBF₄, LiAsF₆, LiBOB, LiDFOB, LiClO₄, LiFSI, LiTFSI LiTf. One or more lithium salts may be present in the ionic liquid electrolyte.

The ionic liquid electrolyte component of the energy storage device provided in step 110 includes a high concentration of lithium salt. As used herein, the phrase “high concentration of lithium salt” means higher than 1.2M, which is a current industry standard for lithium salt in ionic liquid electrolytes. In some embodiments, the high lithium salt concentration is greater than or equal to 1.8M, greater than or equal to 2.4M, greater than or equal to 3.0M, greater than or equal to 3.6M, or greater than or equal to 4.2M. In some embodiments, the lithium salt concentration is in the range of from about 2.4M to about 3.6M, such as about 2.4M to about 3.0M.

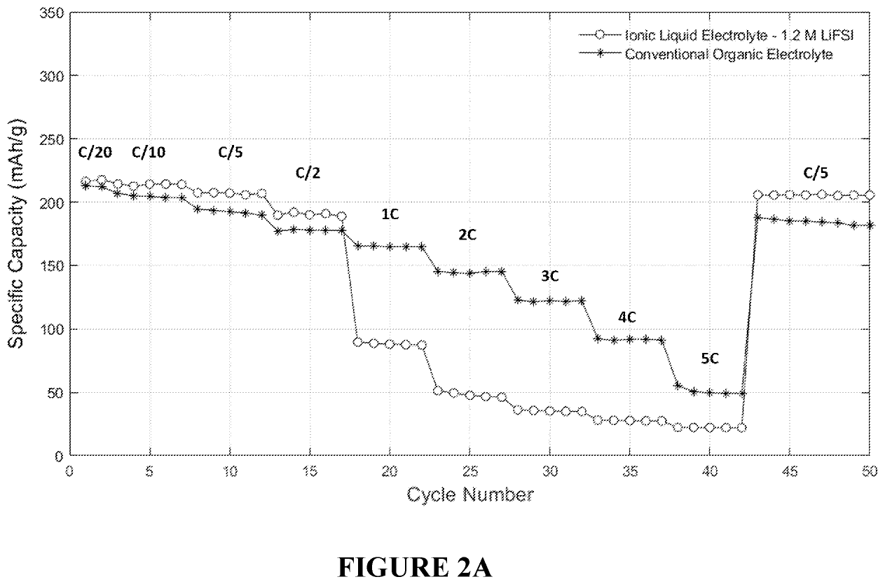

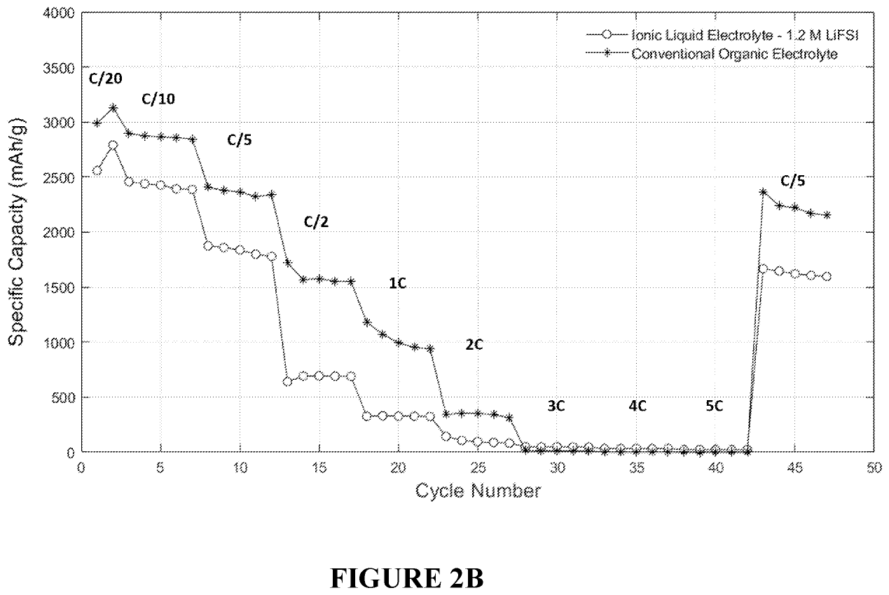

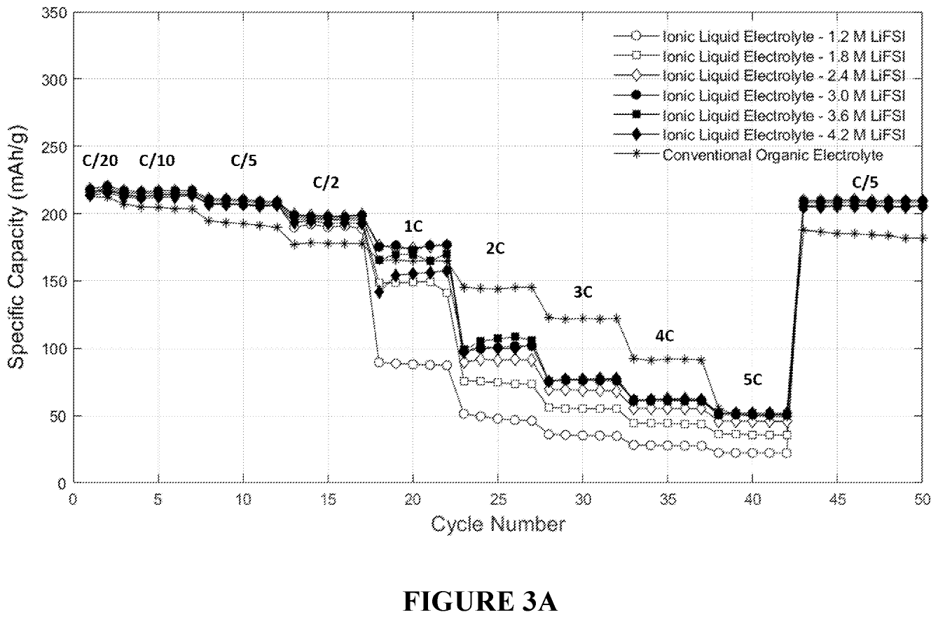

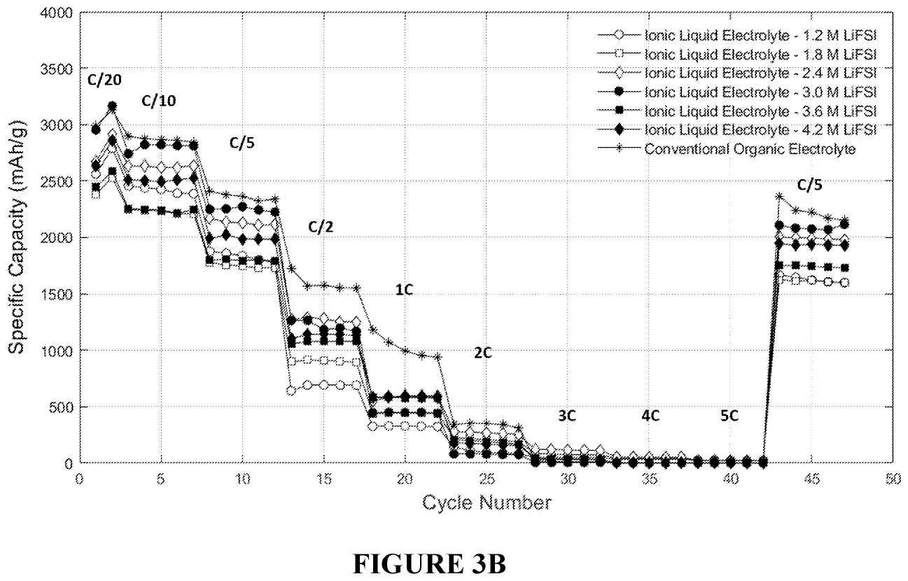

In step 120, the energy storage device is charged and discharged. In some embodiments, the energy storage device is charged and discharged multiple times (long term cycling), and the charge and discharge may also be performed quickly (cycling rate). As discussed in further detail below with respect to FIGS. 2A-3B, the cycling performance (both rate and longevity) is improved by virtue of the high concentration of lithium salt in the ionic liquid electrolyte.

With reference to FIGS. 2A and 2B, the performance of high energy electrodes using ionic liquid electrolytes without high lithium salt concentration is shown. FIG. 2A demonstrates the performance of a half-cell configuration using a NMC-811 cathode against a lithium metal counter electrode. Tests were run using a previously known ionic liquid electrolyte [1.2 M lithium bis(fluorosulfonyl)imide (1.2 M LiFSI) in N-methyl-N-propylpyrrolidinium bis(fluorosulfonyl)imide (PYR₁₃FSI)] as well as a conventional organic electrolyte [1.0 M lithium hexafluorophosphate (1.0 M LiPF₆) in a 1:1 by volume mixture of ethylene carbonate: diethyl carbonate (EC:DEC)]. FIG. 2B demonstrates the performance of a half-cell configuration using a silicon anode against a lithium metal counter electrode. Tests were run using a previously known ionic liquid electrolyte [1.2 M lithium bis(fluorosulfonyl)imide (1.2 M LiFSI) in N-methyl-N-propylpyrrolidinium bis(fluorosulfonyl)imide (PYR₁₃FSI)] as well as a conventional organic electrolyte [1.0 M lithium hexafluorophosphate (1.0 M LiPF₆) in a 1:1 by volume mixture of ethylene carbonate: diethyl carbonate (EC:DEC)]. As shown in FIGS. 2A and 2B, as the charge/discharge rate is increased from C/20 (full charge in 20 hours) to 5C (full charge in 12 minutes), the achievable capacity drops off quickly for the cells with the ionic liquid electrolyte having low lithium salt concentration, while the cells cycled in conventional organic electrolyte perform significantly better up to a 2C rate.

With reference to FIGS. 3A and 3B, the same tests as described above with respect to FIGS. 2A and 2B were run, but using ionic liquid electrolyte having higher lithium salt concentration (1.8M, 2.4M, 3.0M, 3.6M and 4.2M). FIGS. 3A and 3B show how an increase in the lithium salt concentration in the ionic liquid electrolyte significantly improves the performance of both NMC-811 and silicon half-cells. For the NMC-811 cells, the improvements are most evident at rates of C/2 and higher. The silicon cells, however, show improvement of the ionic liquid electrolytes at all rates. The lowest LiFSI concentration (1.2 M—the previously known concentration for Lithium salts in ionic liquid electrolytes) typically shows the worst performance. While higher concentrations all show improvement over the 1.2M concentration, it is noted that the best performing ionic liquid is not necessarily the highest concentration solution (4.2 M). In some embodiments, the intermediate concentrations (2.4 and 3.0 M) show the best cycling performance, indicating that additional salt content can inhibit rate performance (though still perform better than previously known concentrations).

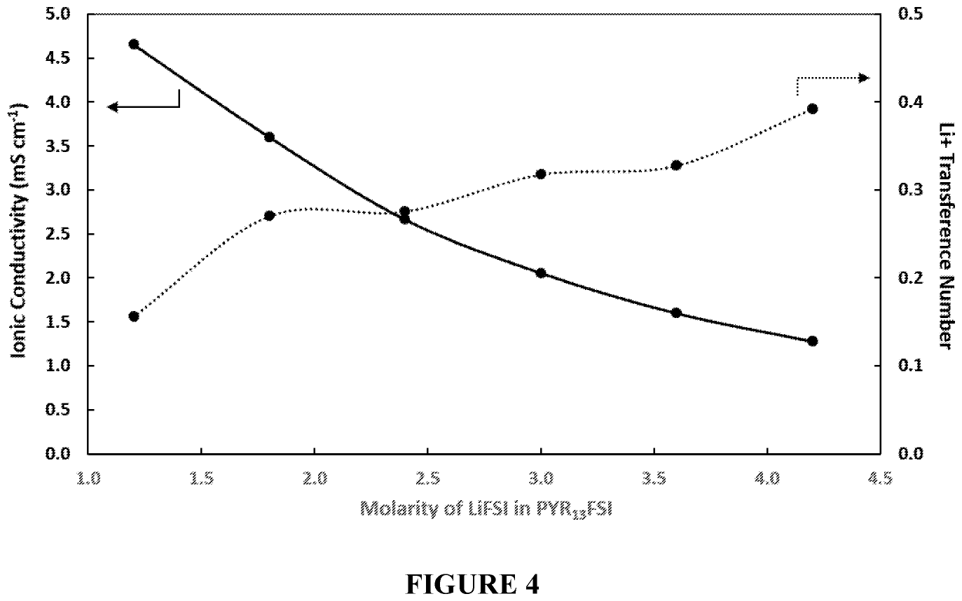

With reference to FIG. 4, measurements of ionic conductivities and lithium-ion transference numbers as a function of LiFSI concentration is shown. As shown in FIG. 4, ionic conductivity decreases with increasing salt content, presumably related to an increase in solution viscosity. While a decrease in ionic conductivity generally results in inferior rate capabilities, the results of this study shows a contrary trend. Improvements in rate performance despite decreases in ionic conductivity may be attributable to the increase in lithium-ion transference number, also shown in FIG. 4, as higher LiFSI concentrations facilitate lithium-ion transport through the electrolyte.

The above described method improves energy storage device performance, specifically with respect to rate cycling (high charge/discharge rates) and long-term stability (long term cycling). Long term stability is even improved at high rate cycling. These improvements are seen in both anode and cathode materials. As discussed above, the previously described method also shows improved dendrite suppression with respect to lithium-metal anodes.

FIG. 1 and the preceding paragraphs describe a method for improving the performance of ionic liquid electrolytes in lithium-ion batteries. However, it should be appreciated that the energy storage device of the described method also forms a part of the technology described herein. Accordingly, in some embodiments, an energy storage device comprising a cathode, an anode, and a high lithium salt concentration ionic liquid electrolyte is described, wherein each of the components of the energy storage device are in accordance with the description provided previously.

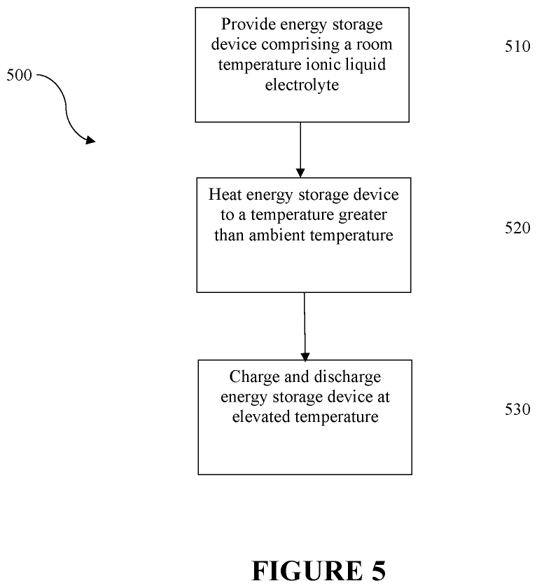

With reference to FIG. 5, a method 500 for improving the performance of ionic liquid electrolytes in lithium-ion batteries according to various embodiments described herein generally includes a step 510 of providing an energy storage device comprising a room temperature ionic liquid electrolyte, a step 520 of heating the energy storage device to a temperature greater than ambient temperature, and a step 530 charging and discharging the energy storage device at the elevated temperature.

With respect to step 510, the energy storage device provided is similar or identical to the energy storage device provided in step 110, with the exception that the ionic liquid electrolyte component of the energy storage device may comprise a standard lithium salt concentration (e.g., 1.2M).

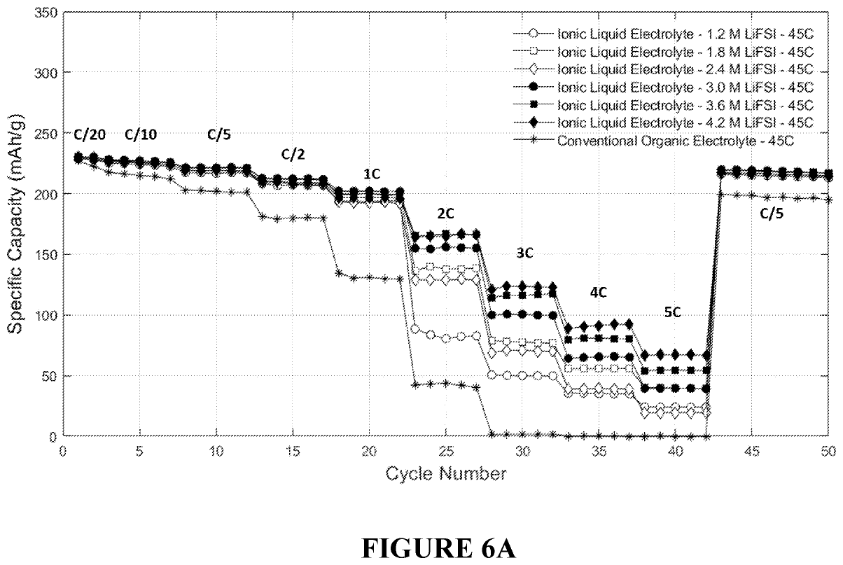

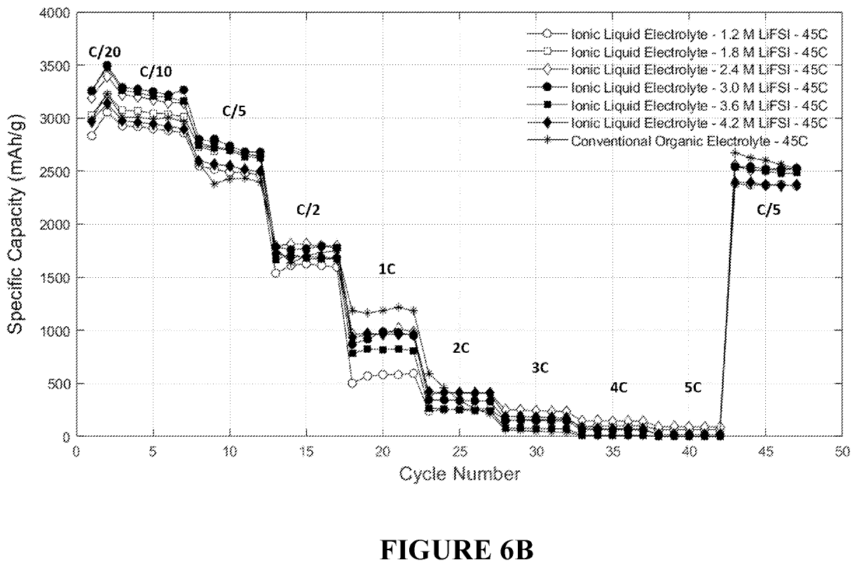

With reference to step 520, the energy storage device is heated to a greater temperature than ambient temperature. An aim of this heating step is to improve cycling performance as described in greater detail below with respect to FIGS. 6A and 6B. In some embodiments, the heating is to a temperature greater than about 22° C. (ambient temperature). In some embodiments, the energy storage device is heated to a temperature of from above 22° C. to about 60° C., such as about 45° C. Heating in this manner has been found to counteract viscosity-related performance limitations sometimes experienced with ionic liquid electrolytes. Any methods and/or equipment can be used to heat the energy storage device to the desired elevated temperature.

In step 530, the energy storage device is charged and discharged. In some embodiments, the energy storage device is charged and discharged multiple times (long term cycling), and the charge and discharge may also be performed quickly (cycling rate). As discussed in further detail below with respect to FIGS. 6A and 6B, the cycling performance (both rate and longevity) is improved by virtue of heating the energy storage device to above ambient temperature, such as to about 45° C.

FIGS. 6A and 6B illustrate how cycling the cells at slightly elevated temperatures enhances the performance of the ionic liquid electrolytes. FIGS. 6A and 6B specifically show test data for embodiments where cells were cycled at 45° C. As shown, the elevated temperature improved the capacities of all of the ionic liquid cells while the organic electrolyte suffered from thermally induced capacity degradation. For the NMC-811 cells (FIG. 6A), all of the ionic liquids outperformed the conventional organic electrolyte. For the silicon cells (FIG. 6B), the ambient heating resulted in capacities significantly higher than those obtained at room temperature and approximately equivalent to those obtained with the conventional electrolyte at 45° C.

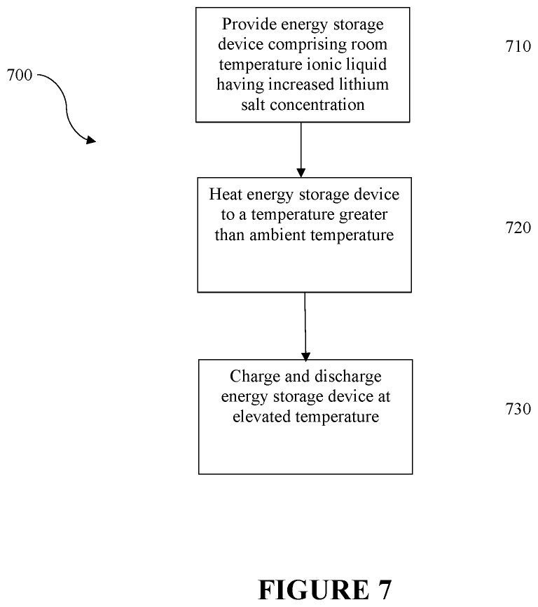

With reference to FIG. 7, a method 700 for improving the performance of ionic liquid electrolytes in lithium-ion batteries according to various embodiments described herein generally includes a step 710 of providing an energy storage device comprising a room temperature ionic liquid electrolyte having an increased lithium salt concentration, a step 720 of heating the energy storage device to a temperature greater than ambient temperature, and a step 730 charging and discharging the energy storage device at the elevated temperature.

With respect to step 710, the energy storage device provided can be similar or identical to the energy storage device provided in step 110 of method 100 illustrated in FIG. 1 and as described in greater detail above, including use of an electrolyte having an increased lithium salt concentration. With respect to step 720, the heating step can be similar or identical to the heating step 520 of method 500 illustrated in FIG. 5 and as described in greater detail above, including heating the energy storage device to temperatures up to about 60° C. With respect to 730, the charge/discharge step can be similar or identical to steps 120 and 530 of FIGS. 1 and 5, respectively, and as described in greater detail above. As with steps 120 and 530, the energy storage device is charged and discharged multiple times (long term cycling), and the charge and discharge may also be performed quickly (cycling rate). As shown in FIGS. 6A and 6B, the cycling performance (both rate and longevity) is improved by virtue of the increase lithium salt concentration and heating the energy storage device to above ambient temperature.

The technology described herein generally relates to the use of ionic liquid electrolytes in lithium ion batteries. While not wishing to be bound by theory, it is proposed that any ionic liquid electrolyte will work with the embodiments described herein since all ionic liquid electrolytes exhibit the high levels of lithium-ion hopping as the transport mechanism within the solution. While diffusion of solvated ions requires movement of the entire solvation structure, the hopping mechanism involves transport of just the lithium-ions while the bulk solution remains relatively immobile. The high rate capabilities demonstrated herein suggest that the lithium-ion transport occurs primarily by means of the hopping mechanism. Since the lithium-ion hopping mechanism requires less movement and less interaction of the solution constituents, it is proposed that the methods presented herein are applicable to a broad range of ionic liquid electrolyte chemistries.

With respect to the testing performed and summarized in FIGS. 2A-4, 6A and 6B, additional information regarding testing parameters is provided below.

Electrode Preparation

All NMC-811 cathodes were prepared with a 92:4:4 mass ratio of NMC-811 powder, carbon black (Alfa Aesar), and polyvinylidene fluoride (Arkema), respectively. A slurry was created by mixing the powders together with 1-methyl-2-pyrrolidone (Sigma Aldrich) using a mortar and pestle. The cathode slurry was then cast onto aluminum foil using an automatic film applicator. Cathode sheets were dried for at least 4 hours at 60° C. and then punched into ½ inch diameter discs which were then dried overnight in a vacuum oven at 120° C. All silicon anodes were prepared with a 7:3 mass ratio of nano-silicon powder (Alfa Aesar) and poly(acrylonitrile) (Sigma Aldrich), respectively. A slurry was created by mixing the powders together with N, N-dimethylformamide (Sigma Aldrich) using a mortar and pestle and subsequently mixed overnight via magnetic stir bar. The anode slurry was then cast onto copper foil using an automatic film applicator. Anode sheets were dried for at least 4 hours at 60° C. and then punched into ½ inch diameter discs. The anode discs were then heat treated at 270° C. for 3 hours under argon. All electrode discs were weighed prior to use to determine active material mass loading for each cell. All cathode punches fell within 6.14-6.53 mg/cm² of NMC. All anodes punches fell within 0.71-0.95 mg/cm² of silicon.

Electrolyte Preparation

All ionic liquid electrolytes were prepared by mixing LiFSI salt (Henan Tianfu Chemical Co.) into PYR₁₃FSI ionic liquid (Solvionic) in various molar ratios. The solutions were mixed by hand over the course of several days to allow for full dissolution of the salt prior to use. The organic electrolyte (1.0 M LiPF₆ in EC:DEC, Sigma Alrich) was used as received.

Cell Construction

All half-cells were assembled in an argon-filled glovebox using CR2032 coin cell components (Pred Materials). Aluminum-clad cathode cups were used for all NMC-811 cells. Prepared NMC-811 cathodes and silicon anodes were used as working electrodes with lithium metal foil (Alfa Aesar) as the counter electrode. Separators were prepared from glass microfiber discs (Whatman GF/F). All cells were flooded with an ample amount of electrolyte solution.

Electrochemical Cycling

Electrochemical cycling tests were performed on Arbin BT2000 testing systems. All cells were cycled under galvanostatic conditions without voltage holds. Cathode half-cells were symmetrically charged (NMC delithiation) then discharged (NMC lithiation) between 3.0 and 4.5 V (vs. Li/Li⁺). Anode half-cells were symmetrically discharged (silicon lithiation) and charged (silicon delithiation) between 50 mV and 1.0 V (vs. Li/Li⁺). All cells were initially cycled at a rate of C/20 for 2 cycles, followed by sets of 5 cycles at progressively faster rates up to a rate of 5C. Cells then resumed continuous cycling at a rate of C/5. C-rates were determined based on the active material mass loading of each electrode and the typical standard capacity of the active materials (200 mAh/g of NMC-811, 3500 mAh/g of silicon). Similarly, all capacity measurements presented herein are normalized by the active material mass loading within each cell.

Ionic Conductivity

Ionic conductivity measurements were performed at room temperature (about 22° C.) using a Metrohm 912 Conductometer equipped with a four electrode measurement cell.

Transference Number

The lithium transference number (t_{+,Li}) of each electrolyte was determined using the potentiostatic polarization method. Lithium foil electrodes were separated by a glass microfiber disc (Whatman GF/F) and flooded with the subject electrolyte solution. EIS measurements were conducted on a Solartron 1280C workstation at frequencies from 20 kHz to 10 mHz with an AC amplitude of 1 mV vs. open circuit. EIS scans were performed immediately before and after a potentiostatic polarization at 1 mV for 1 hour. All measurements and polarizations were performed at room temperature (approximately 22° C.).

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all numbers or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A method of improving the performance of an energy storage device, comprising:
providing an energy storage device, comprising:
an electrode, and
a room temperature ionic liquid electrolyte comprising a solvent and a lithium salt, wherein the concentration of the lithium salt in the room temperature ionic liquid electrolyte the lithium salt is greater than 1.2M;
charging the energy storage device; and
discharging the energy storage device.

2. The method of claim 1, wherein the electrode is a cathode.

3. The method of claim 2, wherein the cathode comprises a Nickel/Manganese/Cobalt cathode, a Nickel/Cobalt/Manganese cathode, a Nickel/Cobalt/Aluminum cathode, a Nickel/Manganese/Cobalt/Aluminum cathode, or a Lithium/Cobalt/Oxide cathode.

4. The method of claim 2, wherein the cathode is uncoated.

5. The method of claim 1, wherein the electrode is an anode.

6. The method of claim 5, wherein the anode comprises a graphite anode, a silicon anode, a silicon oxide anode, or a lithium-metal anode.

7. The method of claim 5, wherein the anode is uncoated.

8. The method of claim 1, wherein the solvent comprises a cation and an anion, the cation comprises pyrrolidinium, piperidinium, or imidazolium, and the anion comprises bis(fluorosulfonyl)imide or bis(trifluoromethanesulfonly)imide.

9. The method of claim 1, wherein the lithium salt comprises LiFSI, LiTFSI, or both.

10. The method of claim 1, wherein the lithium salt concentration is greater than 1.8M.

11. The method of claim 1, wherein the lithium salt concentration is greater than 2.4M.

12. The method of claim 1, wherein the lithium salt concentration is greater than 3.0M.

13. The method of claim 1, wherein the lithium salt concentration is in the range of from 2.4M to 4.0M.

14. The method of claim 1, wherein the lithium salt concentration is in the range of from about 2.4M to about 3.0M.

15. A method of improving the performance of an energy storage device, comprising:
providing an energy storage device, comprising:
an electrode, and
a room temperature ionic liquid electrolyte comprising a solvent and a lithium salt;
heating the energy storage device to a temperature above ambient temperature;
charging the energy storage device; and
discharging the energy storage device.

16. The method of claim 15, wherein the electrode is a cathode.

17. The method of claim 16, wherein the cathode comprises a Nickel/Manganese/Cobalt cathode, a Nickel/Cobalt/Manganese cathode, a Nickel/Cobalt/Aluminum cathode, a Nickel/Manganese/Cobalt/Aluminum cathode, or a Lithium/Cobalt/Oxide cathode.

18. The method of claim 16, wherein the cathode is uncoated.

19. The method of claim 15, wherein the electrode is an anode.

20. The method of claim 19, wherein the anode comprises a graphite anode, a silicon anode, a silicon oxide anode, or a lithium-metal anode.

21. The method of claim 19, wherein the anode is uncoated.

22. The method of claim 15, wherein the solvent comprises a cation and an anion, the cation comprises pyrrolidinium, piperidinium, or imidazolium, and the anion comprises bis(fluorosulfonyl)imide or bis(trifluoromethanesulfonly)imide.

23. The method of claim 15, wherein the lithium salt comprises LiFSI, LiTFSI, or both.

24. The method of claim 15, wherein the energy storage device is heated to a temperature in the range of greater than 22° C. to about 60° C.

25. The method of claim 15, wherein the energy storage device is heated to a temperature of about 45° C.

26. A method of improving the performance of an energy storage device, comprising:
providing an energy storage device, comprising:
an electrode, and
a room temperature ionic liquid electrolyte comprising a solvent and a lithium salt, wherein the concentration of the lithium salt in the room temperature ionic liquid electrolyte the lithium salt is within the range of about 2.4M to about 3.0M;
heating the energy storage device to about 45° C.;
charging the energy storage device; and
discharging the energy storage device.

27. An energy storage device, comprising:
a cathode;
an electrode; and
a room temperature ionic liquid electrolyte comprising a solvent and a lithium salt, wherein the concentration of the lithium salt in the room temperature ionic liquid electrolyte the lithium salt is greater than 1.2M.
